(19) United States
(12) Patent Application Publication
(10) Pub. No.: US 2013/0042746 A1
(43) Pub. Date: Feb. 21, 2013

(54) Electrical Music Books

(71) Applicant: David Shau, Palo Alto, CA (US)

(72) Inventor: David Shau, Palo Alto, CA (US)

(21) Appl. No.: 13/211,516

(22) Filed: Aug. 17, 2011

(51) Int. Cl. G09B 15/02

(52) U.S. Cl. 84/483.1

(57) ABSTRACT

Electrical music books of the present invention automatically flip pages of music pieces according to the music played by the user that is detected by microphone(s) on the electrical music book. The music notes on the screen are updated according to the progress of the music without needing actions by the user other than playing music. The electrical music books of the present invention also can provide suggestions and/or critics of the music played by the user.

### BACKGROUND OF THE INVENTION

The present invention relates to portable electrical devices, and more particularly to portable electrical music books.

Most musicians find it inconvenient to flip the page of a music book while playing musical instruments. It is desirable to allow a musician to flip the page under voice commands. It is further desirable for an electrical music book to automatically flip by itself according to the player's music. Another inconvenient problem is to go through piles of sheets and books to find a desired piece. It is therefore desirable to provide convenient searches based on the title of the music piece, the period of music, the author, and/or the type of instrument. It is also desirable to be able to search for a music piece according to a musical phrase played by a musician. Besides displaying music scores, it is desirable for an electrical music book to analyze the playing of a musician and provide analysis to the musician.

Bahu in U.S. Pat. No. 4,350,070 disclosed an electrical music book that is a composer's electronic paper. A user can hear the song with an audio playback, or hear the song at a specific tempo and rhythm control. Bahu's music book can neatly organize songs stored in its memory. The composer can search through an index to find a desired piece. However, the search method can be time consuming. The device does not have a microphone so it can not analyze music played by the user.

Jasinski in U.S. Pat. No. 5,689,077 disclosed music score display and audio displays devices. The listener can flip the pages using a foot switch. The displayed music score can be stored onto a compact disk, solving the problem of flipping through books trying to find a nice piece. It does not include a metronome. It has no microphone so it cannot analyze music played by the user. It dose not flip automatically.

Winsky in U.S. Pat. No. 5,739,451 disclosed a hand held electronic music encyclopedia. The device has a touch screen that allows a user to select certain choices including hall of frame, music songs, lyrics, bands, publish year, a search button, song writers, and chart position. It has a touch screen allowing the user to flip the pages by touching the screen. This device is an encyclopedia of music history. It is unable to analyze music using a microphone. It does not include a metronome. It dose not provide hands free page flipping capabilities.

Errico in U.S. Pat. No. 6,809,246 disclosed electronic music display devices that scan a sheet of music then displays it on a screen. It has a large storage of memory allowing the user to have multiple songs to play. Selecting the songs can be done using a foot switch. Unfortunately the song can only be up to 2 pages. It can't flip by itself nor can it flip under voice command. It has no microphone so it cannot analyze music played by the user. It does not have a touch screen. It does not include a metronome or audio play either.

Bittner et al. in U.S. Pat. No. 7,199,266 disclosed an electronic music device that translates music score files into music object files. It can also transpose, resize, expand and mark measures. The user can flip the pages using a touch screen. Although the user can play the songs it displays, it does not flip pages by itself or flip pages under voice commands. It does not have a microphone so it cannot analyze the music played by the user. It does not include a metronome and it does not have the ability to play the song in a selected style from selected composers.

The video game “Rock Band” produced by Harmonix provides video game input devices shaped like drum sets or guitars. Game players feel like they are playing musical instruments while they are just controlling switches of video game input devices to match the tempo of the music played by the video game. The video game compares the pitch of the instrument-like video game input devices to the expected pitch of the music, and then informs the players of the results. It also has a microphone to receive the voice of a singer, but it does not analyze the players' playing; it just measures the pitch of the singer's voice for comparison with the expected pitch based on the reference music. The drums and guitar are just input switches designed to look like the instrument—they cannot generate music. The video game does not show music scores on screen; it just shows rectangles of different colors that represent the pitch of the reference music.

### SUMMARY OF THE PREFERRED EMBODIMENTS

A primary objective of the preferred embodiments is, therefore, to provide an electrical music book that can flip pages of music pieces according to the music played by the user. An objective of the preferred embodiment is to serve the function of a metronome. Another objective of the preferred embodiment is to provide a music encyclopedia. A primary objective of the preferred embodiments is to provide feedback to a musician by comparing the played music with reference music. Another primary objective of the preferred embodiments is to provide convenient search methods to find the desired music piece among large number of music pieces stored in a database. An objective of the preferred embodiments is to search for music pieces according to a music phrase played by a user. Another objective of the preferred embodiments is to provide the capability to distinguish the music played by a user from background noises. These and other objectives are assisted by using a portable electrical device equipped with microphone(s) and signal processing capabilities.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1(a) shows the symbolic view of an example of an electrical book working with a musical instrument;

FIG. 1(b) shows an exemplary symbolic block diagram for the components of the electrical music book in FIG. 1(a);

FIG. 1(c) is a magnified view of the electrical music book in FIG. 1(a);

FIGS. 2(a-m) illustrate exemplary operation procedures for the electrical music book in FIG. 1(a);

FIGS. 3(a, b) show other optional ways in the display of music notes;

FIGS. 4(a, b) show other optional embodiment of metronome function; and

FIG. 5 shows a symbolic view when one electrical music book is supporting two music instruments simultaneously.

### DETAILED DESCRIPTION OF THE PREFERRED EMBODIMENTS

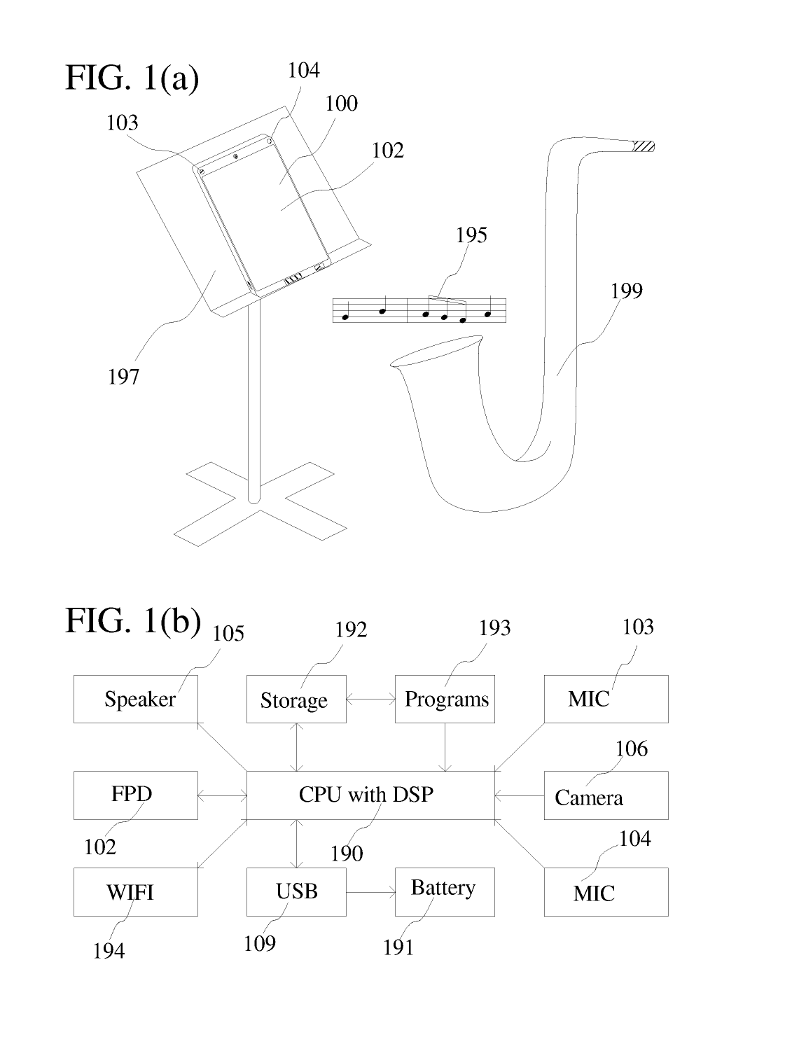

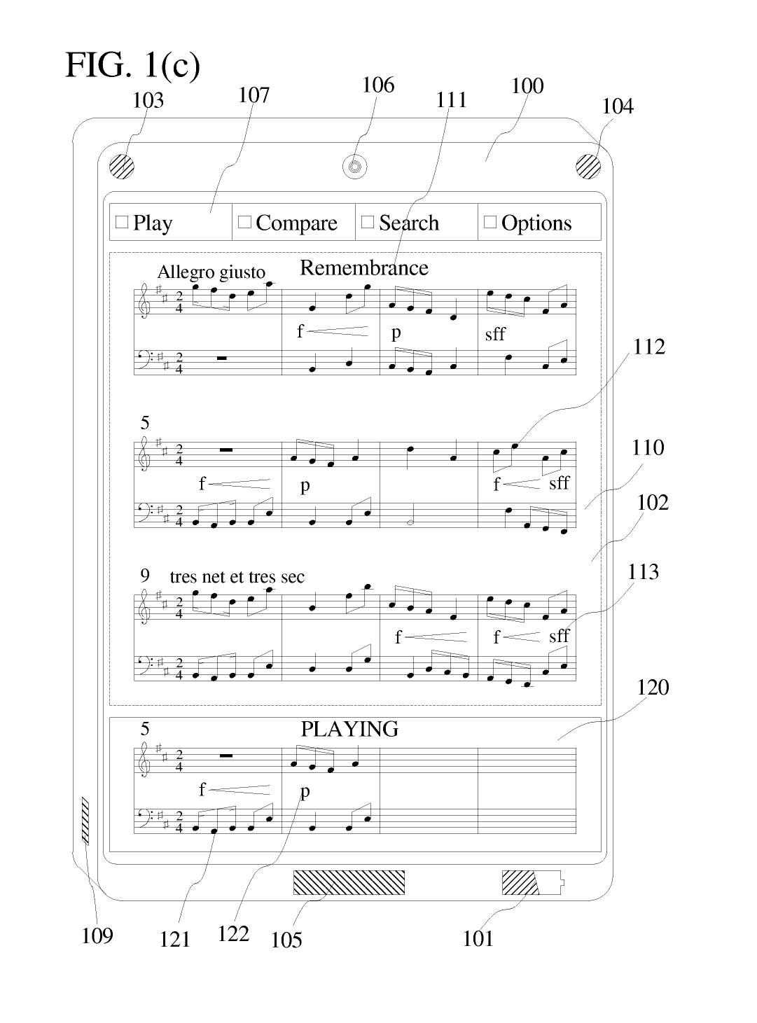

FIGS. 1(a-c) show an example of a music book (100) of the present invention. FIG. 1(a) is a symbolic view of an electrical music book (100) responding to the music (195) played by a music instrument (199). This electrical music book (100) is powered by a battery that is similar to batteries used by cellular phones, notebook computers, or tablet computers. Its screen (102) is a flat panel display (FPD) device with touch screen functions. Typical examples of flat panel display devices are liquid crystal display (LCD) devices or light emitting diode (LED) display devices. The thickness of such music book (100) can be thinner than 1 centimeter, its area can be similar to or smaller than conventional music books, and it can weigh less than 10 pounds. For the example shown in FIG. 1(a), the electrical music book is small enough to be placed on a typical music book stand (197). The music book is equipped with microphones (103-104) that can analyze the music (195) played by a musical instrument (199) to support desired functions.

FIG. 1(b) shows a simplified symbolic block diagram and FIG. 1(c) shows detailed structures for the electrical components of the music book (100) in FIG. 1(a). The electrical music book typically use a flat panel display (FDP) as its display screen (102). FIG. 1(c) shows an example when the screen displays the title (111), the music notes (112) and expression symbols (113) of a music piece (110). The screen (102) typically supports touch screen functions. A user can select desired options by touching the select buttons (107) on the screen (102). An electrical music book of the present invention is equipped with one or more microphones (103, 104) to record the music (195) played by music instrument(s). The played music also can be translated into music notes and displayed on the screen in the “PLAYING” window (120) as shown by the example in FIG. 1(c). In this example, not only the music notes (121) but also the dynamics (122) of the played music (120) are displayed on the screen. Inside the electrical music book there are integrated circuits (IC) such as a central processing unit (CPU) (190) that supports digital signal processing (DSP) operations, as shown by the symbolic diagram in FIG. 1(b). Analyzing the sound detected by microphones (103, 104), the digital signal processing (DSP) circuits can analyze the music (195) played from a musical instrument (199) so that it knows where the musician is at in the music piece. The music book is therefore able to flip pages of the music piece automatically, and display the music notes in the most desirable ways on the screen for the musician. The music book (100) also can compare the music played by the musician to a selected author or style, then critique the musician's music and/or offer suggestions. These abilities can be customized by the musician using touch-screen commands. The electrical music book also comprises storage (192) devices that can store software programs (193) and a large number of music pieces. The storage device can be FLASH memory IC, compact discs (CD), hard discs (HD), or other types of electrical storage devices. To make the music book portable, it is powered by a battery (191). The amount of battery power left is indicated by a battery shaped symbol (101) on the bottom right corner, as illustrated in FIG. 1(c). In this example, the battery is charged through a universal serial bus (USB) port (109) at the side of the music book (100). This USB port (109) also can support wired communications with other electrical devices. Beside wired communication, the music book also may support wireless communication such as WIFI (194). In this example, the music book has a speaker (105) to play music, and a camera (106) to record images.

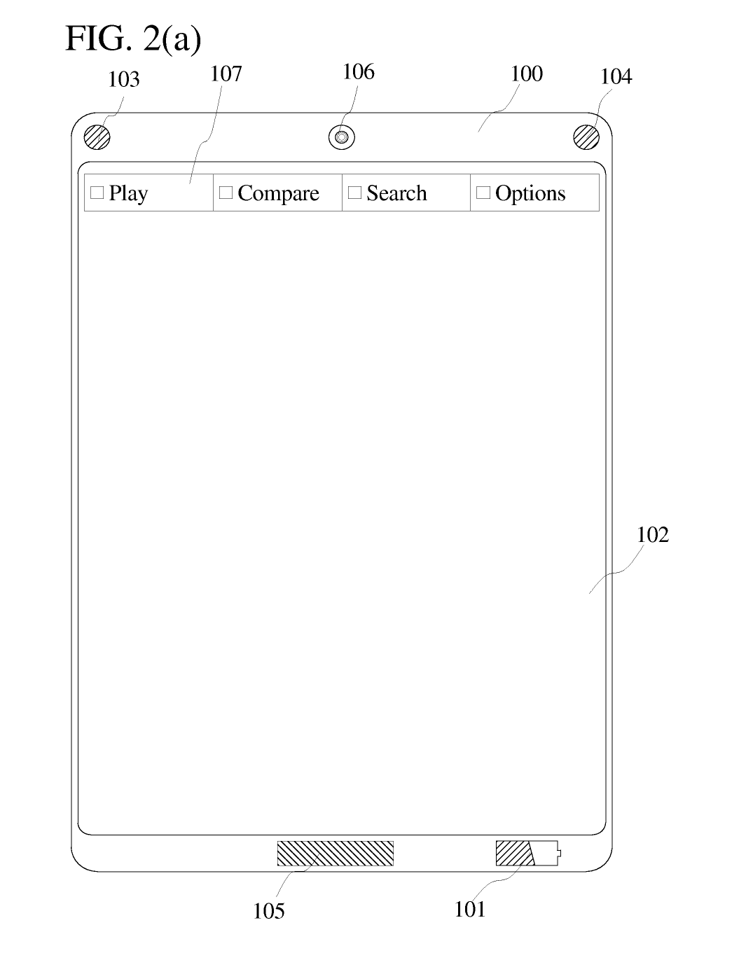

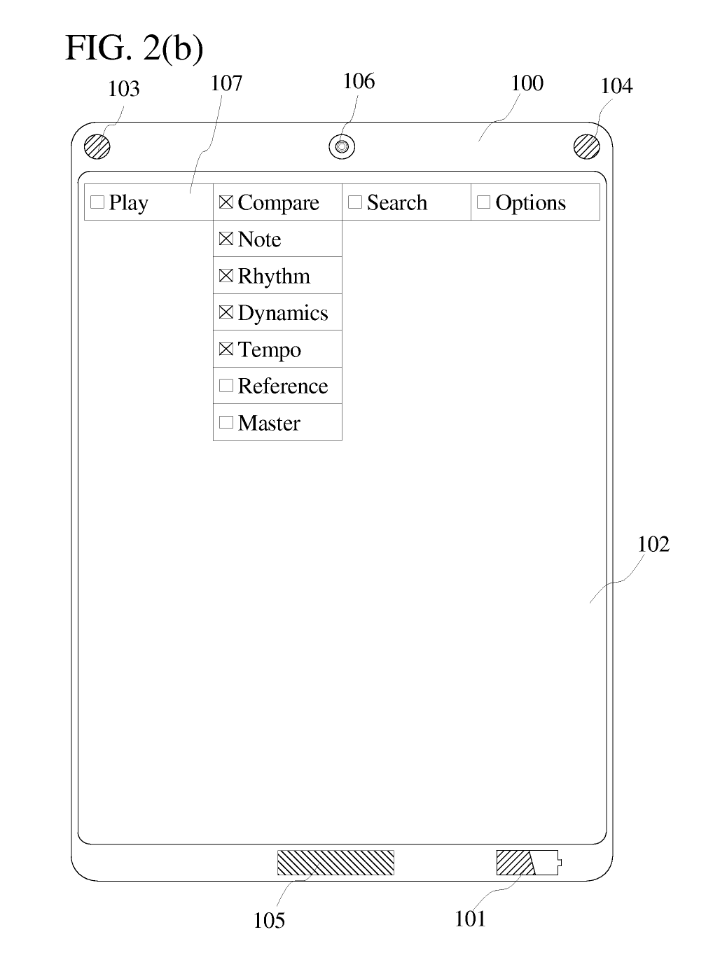

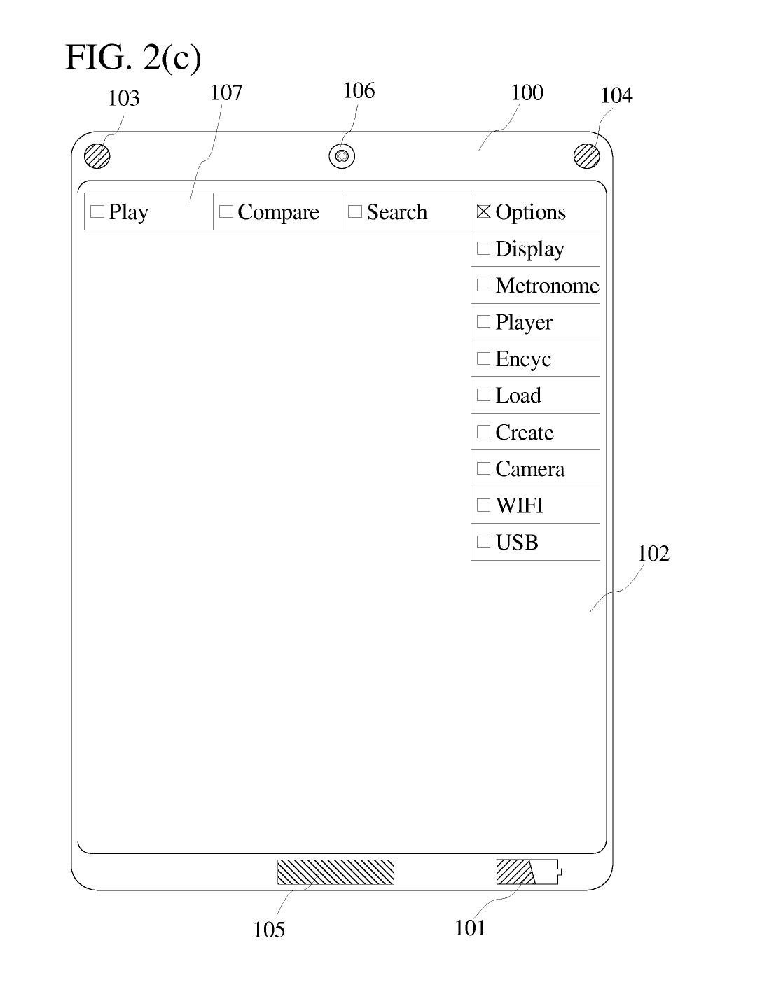

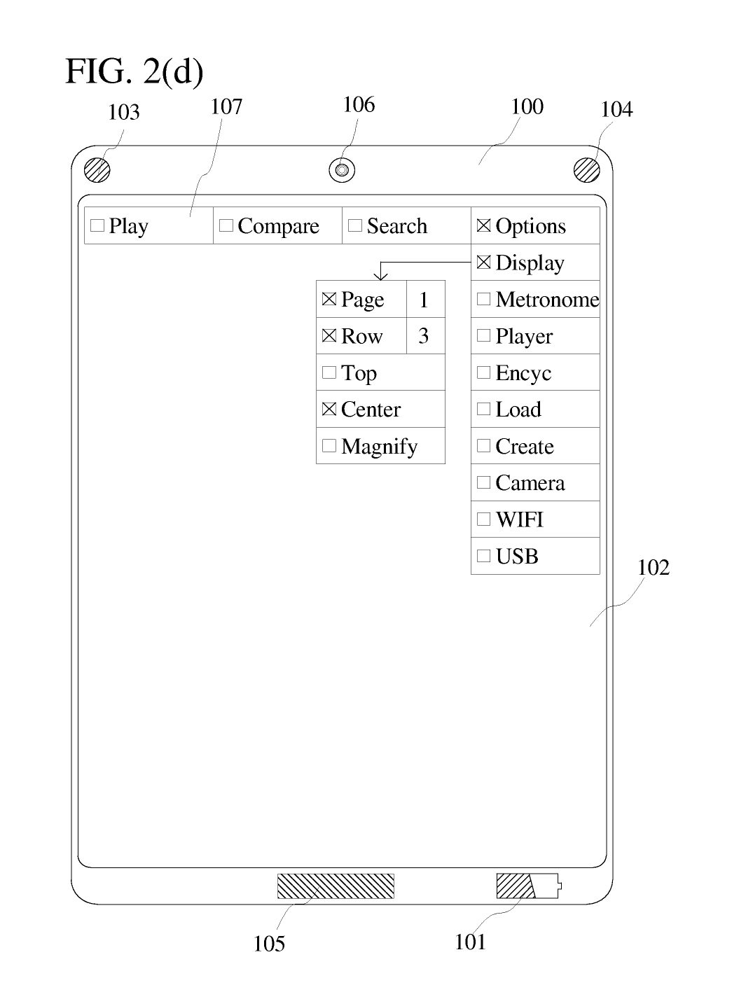

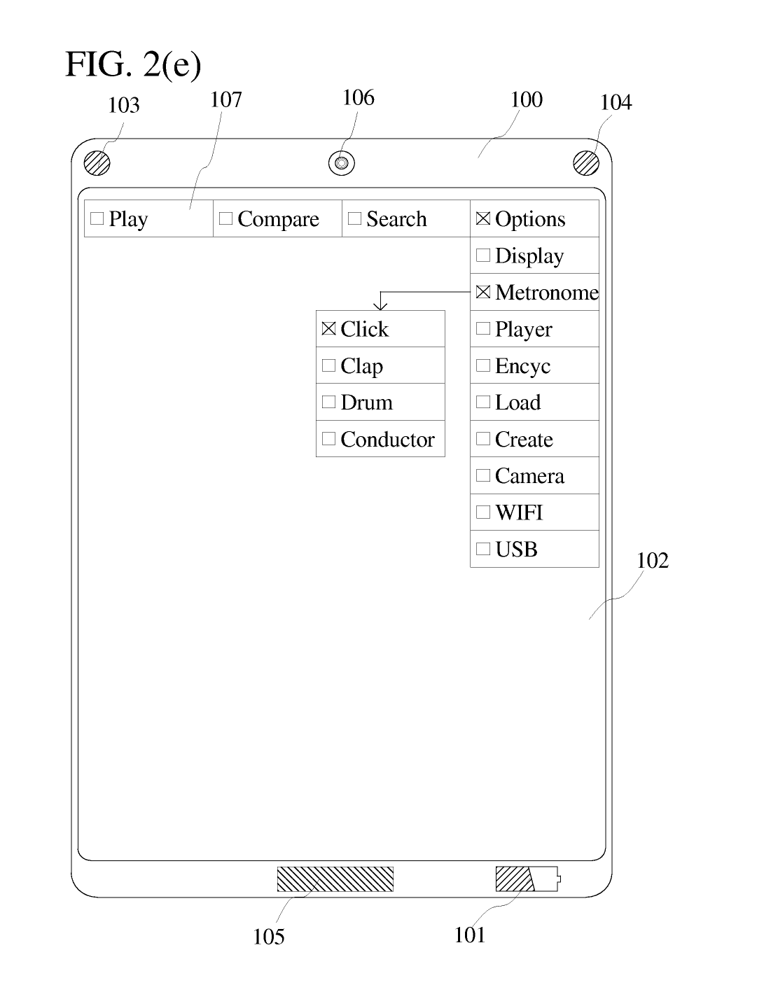

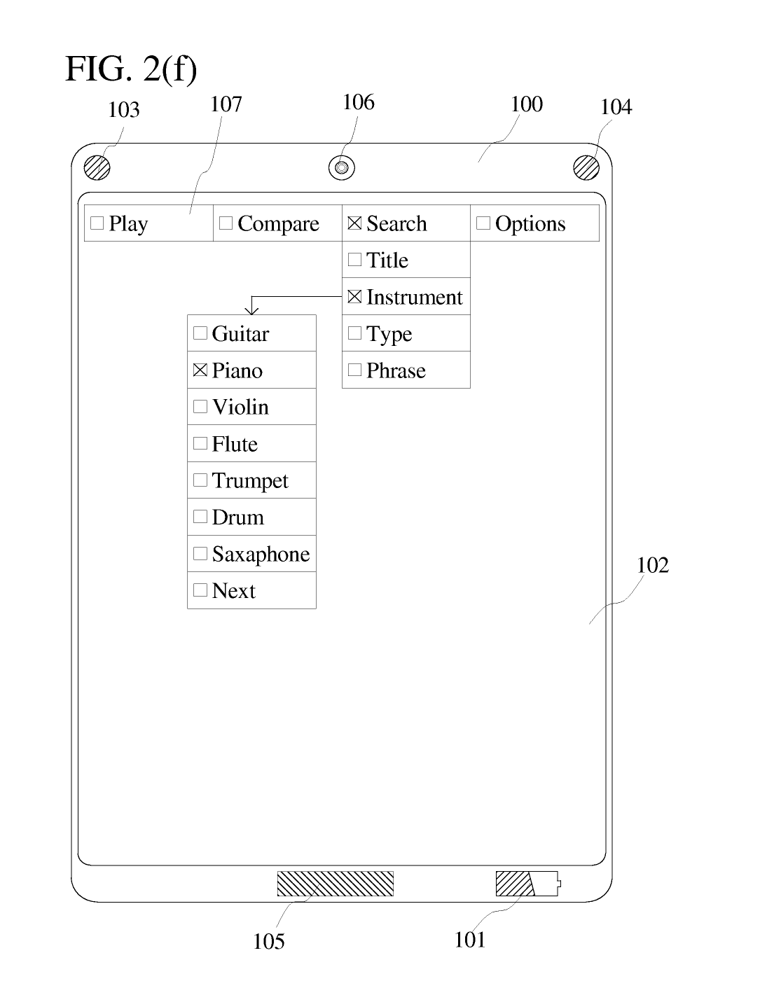

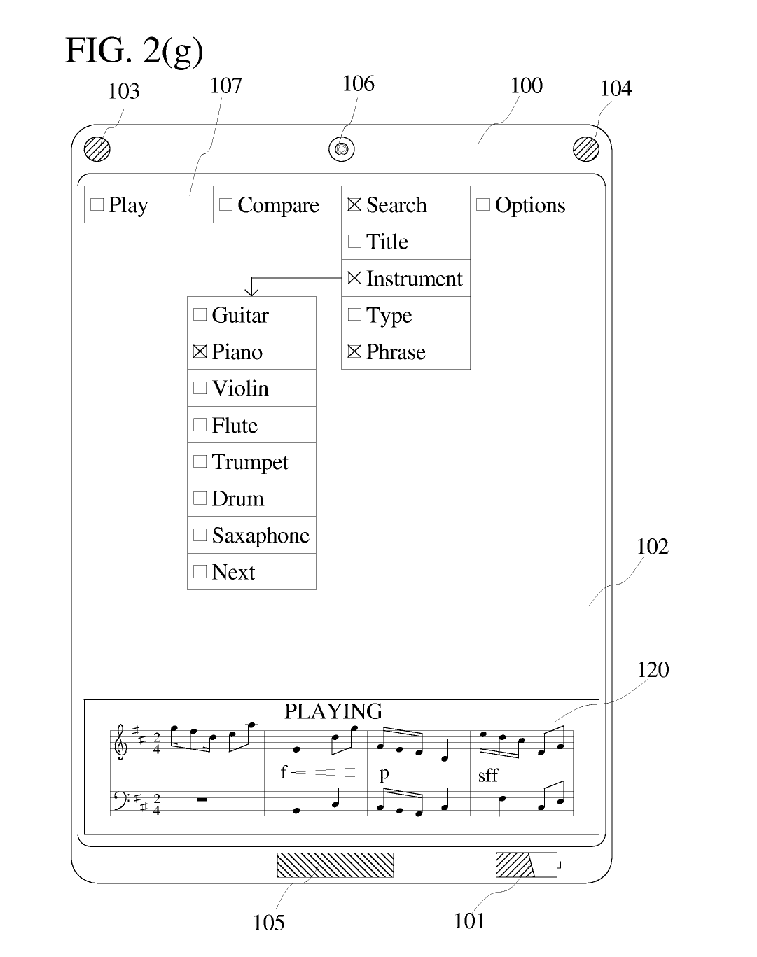

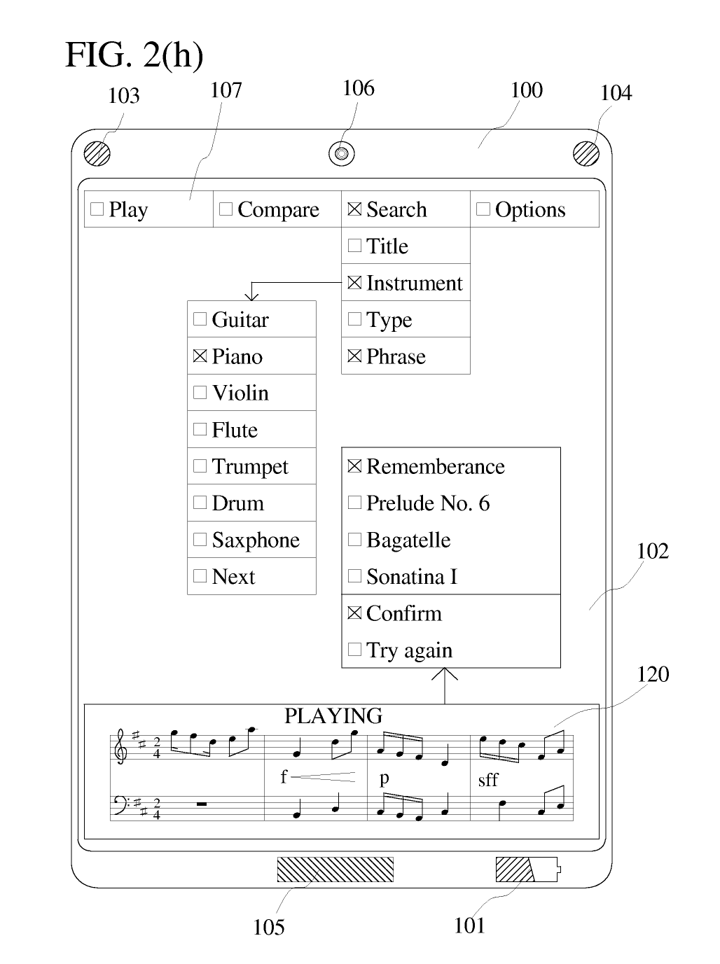

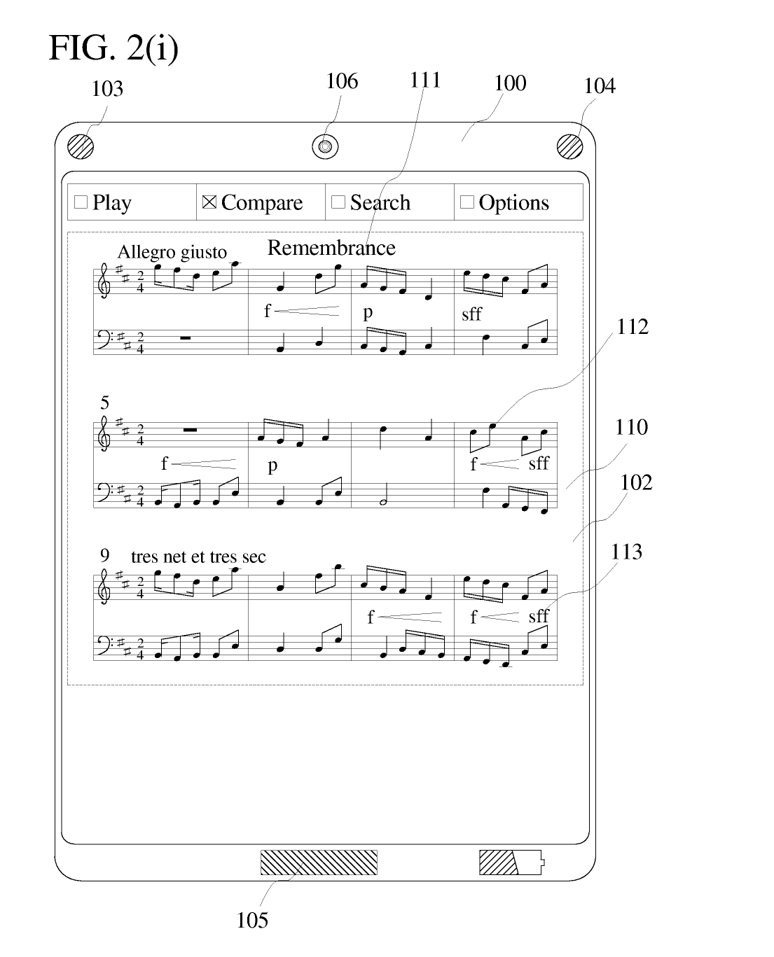

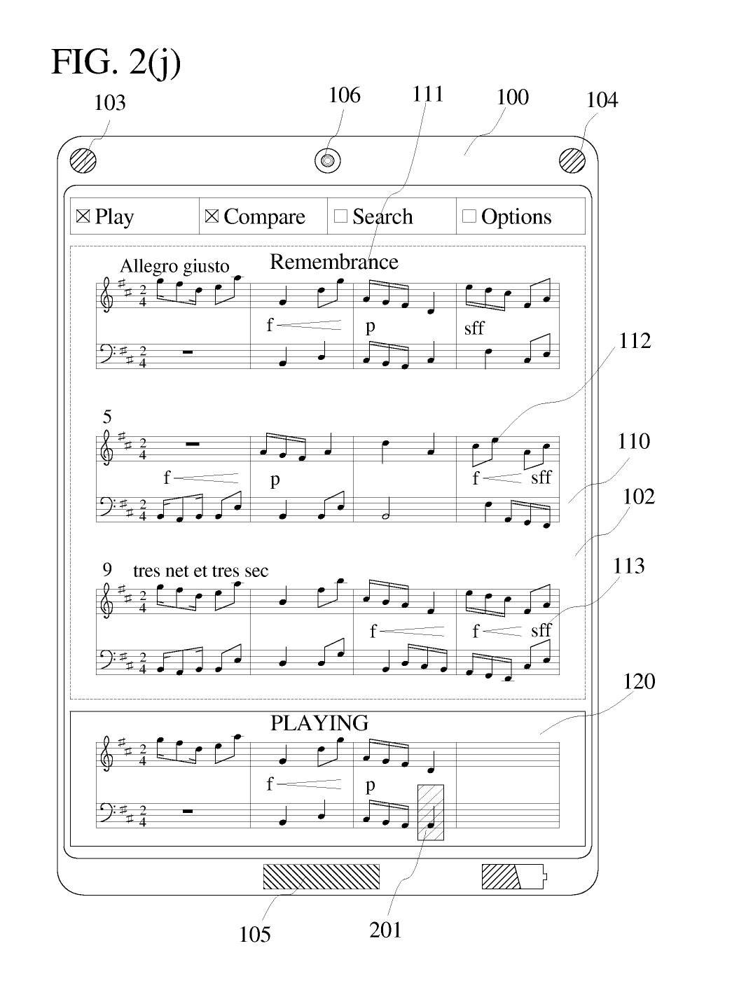

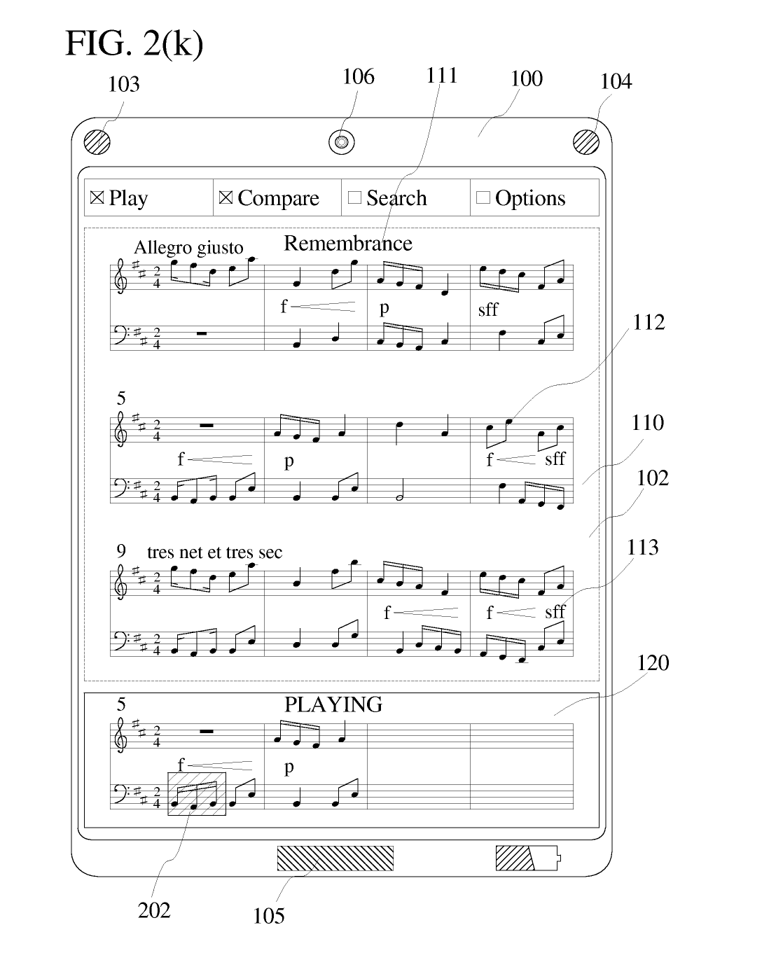

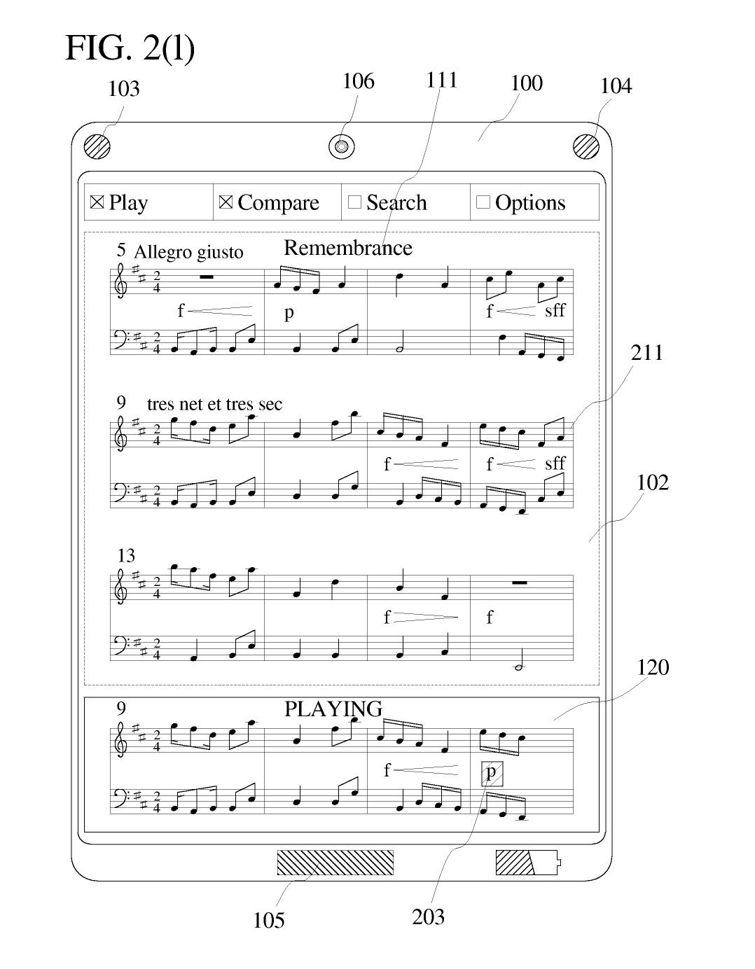

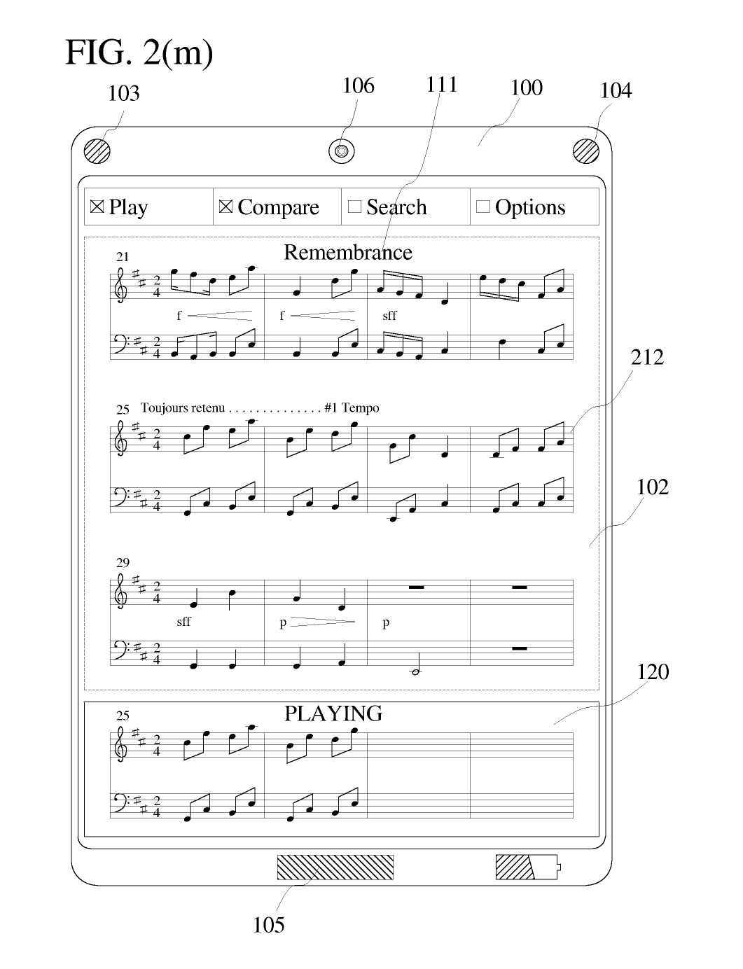

FIGS. 2(a-m) illustrate exemplary operation procedures for the electrical music book (100) shown in FIGS. 1(a-c). When a user just starts, the screen (102) of the electrical music book (100) displays 4 touch screen buttons (107), as illustrated by the front view of the electrical book shown in FIG. 2(a). The user can touch the “Compare” button, and 6 compare options would pop up, as shown in FIG. 2(b). In this case, the user touches “Note”, “Rhythm”, “Dynamics”, and “Tempo” buttons to compare his/her music with the notes, rhythms, dynamics, and tempo on the music book. The user also can touch the “Reference” button to compare his/her music with a selected reference music, or touch the “Master” button to compare with a master piece. Next, the user touches the “Options” button, and 9 options pop up, as shown in FIG. 2(c). The user can touch the “Display” button, and 5 sub-buttons pop up, as shown in FIG. 2(d). In this case, the user chose to display 3 rows of 1 page on the screen, and the row under play would be displayed near the center of the screen (102). The user can touch the “Metronome” button, and the “Click” sub-button, as illustrated in FIG. 2(e) so that the electrical music book (100) will provide a ticking sound to help the user control the tempo of his/her play.

An electrical music book can store hundreds, thousands, or more music pieces in its storage device. It is therefore desirable to provide convenient search methods for the user to select desired music piece out of many options. For the example shown in FIG. 2(f), the user touches the “Search” button, and 4 buttons pop up. The “Title” button would allow the user to search according to the title of music pieces. The “Instrument” button would allow the user to select music pieces related to a particular instrument. The “Type” button would allow the user to select certain types of music such as classical, rock and roll, jazz, or country music. The “Phrase” button allows the user to play a music phrase, and the music book would search its database to find music pieces that contain similar music phrases. For the example shown in FIG. 2(g), the user selects “Piano” as the instrument. In this way, the music book will only search for piano music pieces. At the same time, the user also selects “Phrase” option, and plays a music phrase on his/her piano. The music phrase is detected by the microphones (103, 104) and analyzed by internal DSP circuits; the detected music phrase is displayed in the “PLAYING” window (120), as shown in FIG. 2(g). The electrical music book (100) would search its database to find music pieces with matching or similar phrases. In this case, the search finds 4 music pieces titled “Remembrance”, “Prelude No. 6”, “Bagatelle”, and “Sonatina I”, as illustrated in FIG. 2(h). The search results are listed according to the degree of similarity to the played music phrase. The music book also can play the search results using its speaker (105). If all the search results are not what the user wants, the user can touch the “Try again” sub-button to start another search. For the example in FIG. 2(h), the user confirms that “Remembrance” is the desired music piece. The first three rows of the music piece “Remembrance” is therefore displayed on the screen, including its title (111), music notes (112), and expression symbols (113), as illustrated in FIG. 2(i).

Now the user can touch the “Play” button and starts playing music. The DSP circuits in the electrical music book (100) would analyze the played music detected by its microphones (103, 104), and display the results on the “PLAYING” window (120). For the case shown in FIG. 2(j), the user has played three measures of music, and he made a mistake on one note, which was marked by a shaded rectangle (201). As the user continues to play, the electrical music book would update the “PLAYING” window (120). FIG. 2(k) illustrates the situation when the user has played two measures in the second row, and a rhythm mistake is found and marked by another shaded rectangle (202). As the user plays into the third row, the electrical music book automatically centers the third row (211) of the music piece at the center of the display screen and brings in the forth row, as shown in FIG. 2(l). This is done by analyzing the music played by the user so that the user does not need to use his hand or leg to flip pages while playing. In the mean time, the electrical music book continues to update the “PLAYING” window (120). For the example shown in FIG. 2(l), the user plays all notes and rhythm correctly, but the last measure was played too softly, and the mistake was marked by a shaded rectangle (203). As the user continues to play, the electrical music book always displays the row the user is playing near the center, updates the played music, and marks mistakes. FIG. 2(m) illustrates the display when the user is playing the second measure of the 6^{th} row (212). At the end of a play, the music book can summarize all the mistakes the user has made.

While the preferred embodiments have been illustrated and described herein, other modifications and changes will be evident to those skilled in the art. It is to be understood that there are many other possible modifications and implementations so that the scope of the invention is not limited by the specific embodiments discussed herein. For example, the electrical music book may have more than one speaker to achieve better sound effects, and it may be able to drive external speakers. The DSP functions may be implemented by software, firmware, or hardware. The electrical music book may have only one microphone, or it may have many microphones. Besides touch screens, other input methods such as voice recognition or motion detection also can be used as command inputs. The user may choose not to display the “PLAYING” window or the critics to his/her music. The music book can display more rows or more pages of the music piece according to his/her choice. Besides the functions of a music book, an electrical music book of the present invention also can support other functions such as an electrical book, a mobile phone, a note pad computer, a laptop computer, a tablet computer, a calendar, or other functions. There are unlimited ways to design the shape, style, operation procedures, and options. For the examples shown in FIGS. 2(i-m), three rows of music notes are displayed, and the row under play is placed at the center. The display of music pieces certainly can be arranged in other ways.

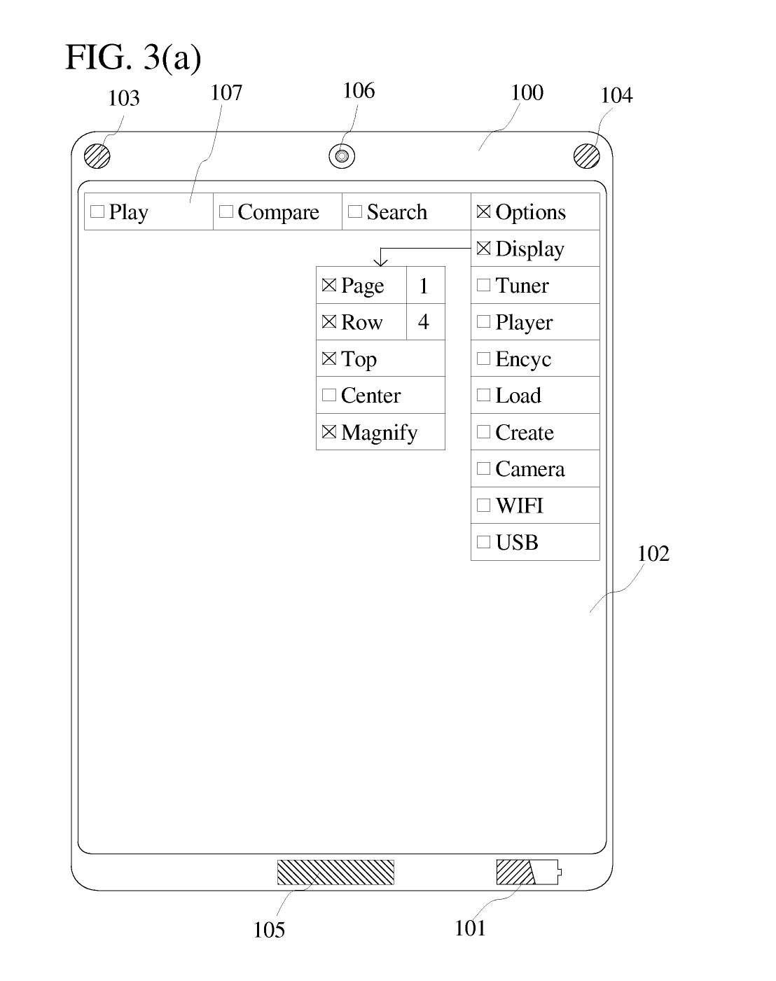

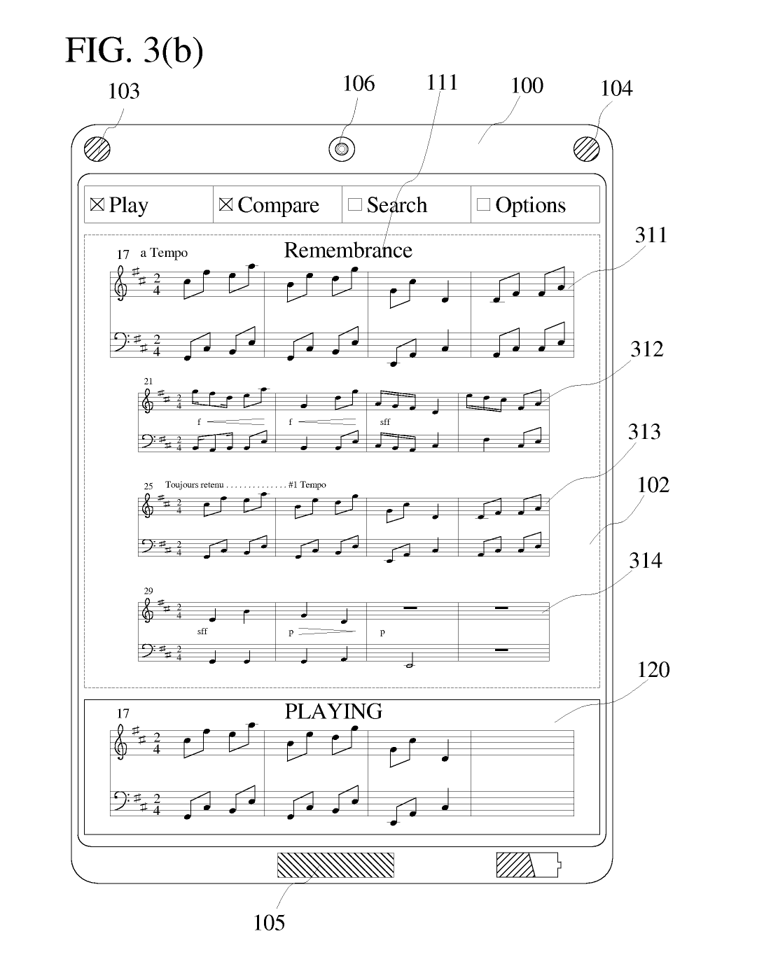

FIG. 3(a) shows an example when the user uses the touch screen to select “Page 1”, “Row 4”, “Top”, and “Magnify” sub-buttons of the “Display” option. FIG. 3(b) shows the resulting display that displays 4 rows (311-314), with the row under play (311) magnified and placed at the top of the screen, as commanded by the selections shown in FIG. 3(a).

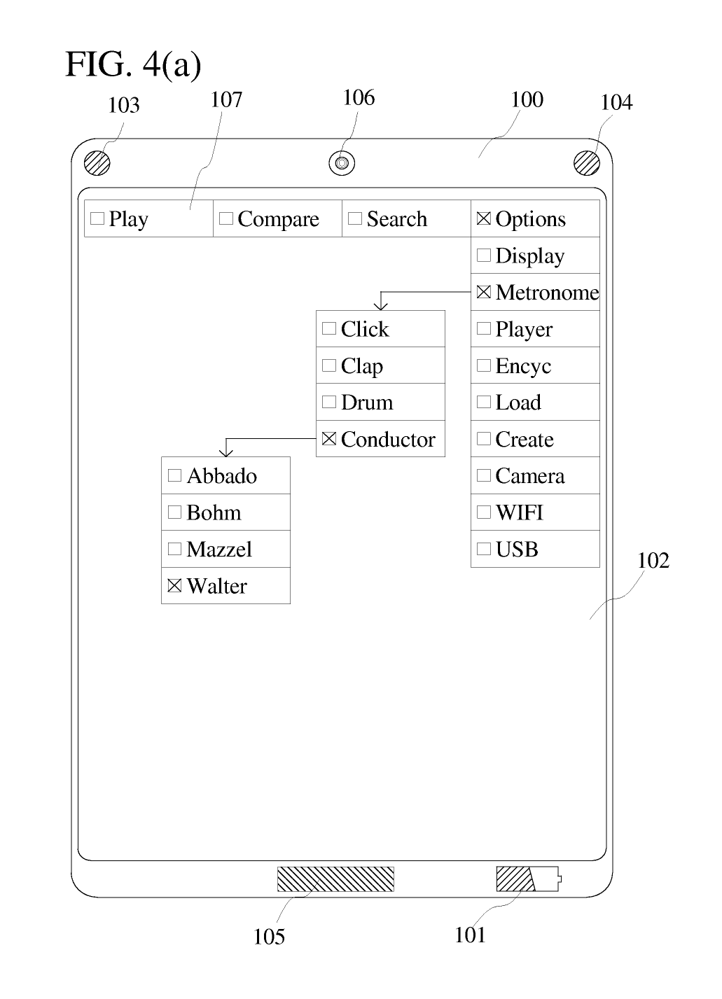

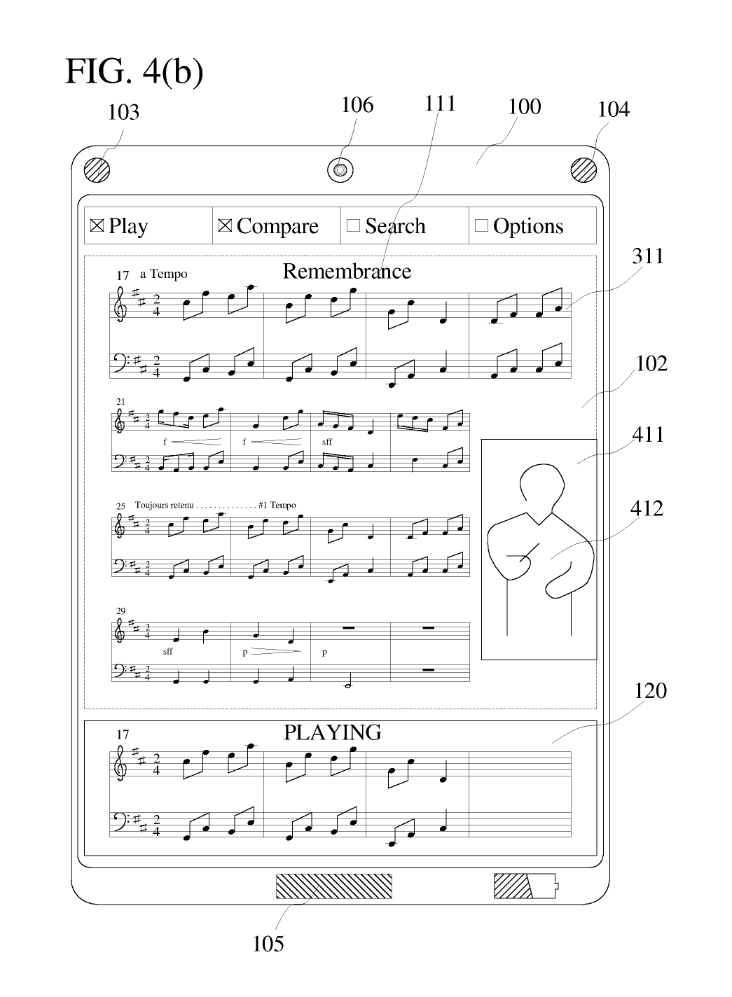

FIG. 4(a) shows another option. The user selects the “Conductor” sub-button of the “Metronome” option, and 4 buttons pop up, allowing the user to select from 4 famous conductors. In this case, the user selects “Walter”, and the image of famous conduct Walter (412) would be shown on the screen (411) conducting for the user while he/she plays the music, as illustrated in symbolic view by FIG. 4(b).

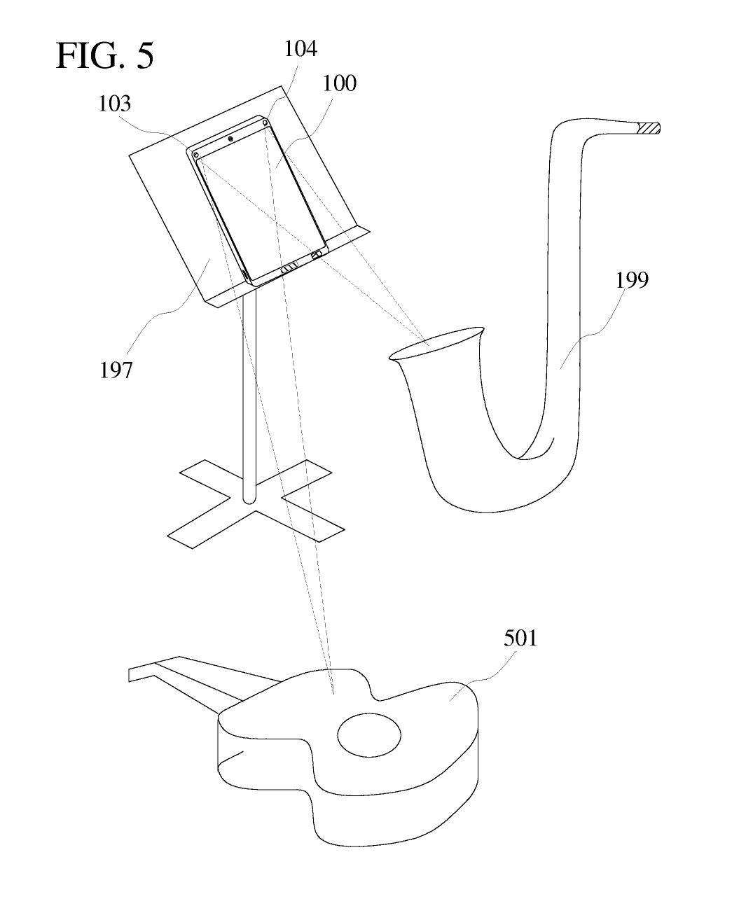

While the preferred embodiments have been illustrated and described herein, other modifications and changes will be evident to those skilled in the art. It is to be understood that there are many other possible modifications and implementations so that the scope of the invention is not limited by the specific embodiments discussed herein. For example, the picture in FIG. 1(a) shows one electrical music book (100) supporting one musical instrument (199) while an electrical music book of the present invention can support multiple musical instruments at the same time. Digital signal processing is capable of distinguishing the sound of different instruments. It is therefore possible to support multiple instruments simultaneously without confusing which sound came from which instrument. Another method to support multiple instruments simultaneously is to use two or more microphones. FIG. 5 shows a symbolic view when an electrical music book (100) is supporting two music instruments (199, 501) at the same time. For this example, the music played by the first instrument (199) will reach the right microphone (104) at a time earlier then the time when it reaches the left microphone (103), and the music played by the second instrument (501) will reach the right microphone (104) at a time later then the time when it reaches the left microphone (103). By comparing the sound detected by microphones placed at different locations, digital signal processing programs are able to separate the sound emitted from different sound sources. It is therefore capable of supporting two or more music instruments simultaneously, even when they are the same types of instruments. Using similar principles, the influence of background noise also can be eliminated.

An electrical music book of the present invention analyzes the sound detected by microphone(s) to know the progress of the music played by the user(s), and then flips pages for the music notes displayed on the screen according to the sound detected by the microphone(s). In this way, a user can concentrate on playing music while the display of music notes would be updated automatically according to the liking of the user. Flipping pages of a music piece on our electrical music book does not need to be one page at a time. The electrical music book can update one or a few rows at a time, update one or a few pages at a time, or update in other ways according to the liking of the user. The music detected by the microphone(s) can be displayed on the screen of the electrical music book, and critics can be displayed according to the options selected by the user. It is typically desirable to install two or more microphones to improve the capability in supporting multiple music instruments simultaneously. Influences of background noises also can be reduced when there are two or more microphones. It is also desirable for the electrical music book to provide the functions of a metronome. One of the options of metronome is to provide the image of a conductor to conduct the music play(s) of the user(s). An electrical music book of the present invention can be a dedicated device; it also can be implemented into other electrical devices such as electrical books, mobile phones, or portable computers.

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. A method for flipping pages for music piece(s) displayed on the screen of an electrical music book, comprising the steps of:
Installing microphone(s) on said electrical music book;
Analyzing the sound detected by said microphone(s) to know where the music played by the user(s) is at in the music piece(s);
Flipping pages for the music piece(s) displayed on the screen of said electrical music book according to the sound detected by said microphone(s).

2. The method in claim 1 further comprises a step of flipping pages by updating one or a few rows of music notes at a time.

3. The method in claim 1 further comprises a step of flipping pages by updating one or a few pages of music notes at a time.

4. The method in claim 1 further comprises a step of displaying the music notes of the music detected by the microphone(s) on the screen of the electrical music book.

5. The method in claim 1 further comprises a step of providing suggestions and/or critics for the music played by the user(s).

6. The method in claim 1 further comprises a step of installing two or more microphones on the electrical music book.

7. The method in claim 1 further comprises a step of providing the functions of a metronome.

8. The method in claim 7 further comprises a step of displaying the image of a conductor to conduct the music play(s) of the user(s).

9. The method in claim 1 further comprises the steps of configuring the electrical music book as a mobile phone.

10. The method in claim 1 further comprises the steps of configuring the electrical music book as a portable computer.

11. An electrical music book comprising:
Storage device(s) that store the music notes of a plurality of music pieces;
A screen that can display the music notes of said music pieces;
Microphone(s) for detecting the music played by the user(s);
Wherein the display of the music notes on the screen of the electrical music book can be updated according to the progress of the music detected by the microphone(s).

12. The electrical music book in claim 11 updates the music notes on the screen of the electrical music book by one or a few rows at a time according to the progress of the music detected by the microphone(s).

13. The electrical music book in claim 11 updates the music notes on the screen of the electrical music book by one or a few pages at a time according to the progress of the music detected by the microphone(s).

14. The electrical music book in claim 11 further displays the music notes of the music detected by the microphone(s) on the screen of the electrical music book.

15. The electrical music book in claim 11 further provides suggestions and/or critics for the music played by the user(s).

16. The electrical music book in claim 11 comprises two or more microphones.

17. The electrical music book in claim 11 further supports the functions of a metronome.

18. The electrical music book in claim 17 displays the image of a conductor to conduct the music play(s) of the user(s).

19. The electrical music book in claim 11 also supports the functions of a mobile phone.

20. The electrical music book in claim 11 also supports the functions of a portable computer.
